(19) United States
(12) Patent Application Publication
(10) Pub. No.: US 2006/0167780 A1
(43) Pub. Date: Jul. 27, 2006

(54) College savings plan account registry and method

(76) Inventor: Gary E. Friedman, Beachwood, OH (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(21) Appl. No.: 11/340,357

(22) Filed: Jan. 26, 2006

Related U.S. Application Data
(60) Provisional application No. 60/647,072, filed on Jan. 26, 2005.

(51) Int. Cl. G06Q 40/00

(52) U.S. Cl. 705/35

(57) ABSTRACT

A registry of college savings plan accounts includes a central database. The database includes a plurality of registry accounts, and each of the registry accounts includes an account number of a college savings plan account and a name of a prospective student included in the college savings plan account. A method for donating funds to a college savings plan account is provided, and a method for managing contributions to a college savings plan account is also provided.

### CROSS-REFERENCE TO RELATED APPLICATION

This application claims the benefit of U.S. Provisional Application Ser. No. 60/647,072, filed on Jan. 26, 2005.

### BACKGROUND OF THE INVENTION

1. Field of the Invention

The present invention relates to the financial planning arts. More particularly, the present invention relates to college savings accounts or plans in the financial planning arts. Still more particularly, the present invention relates to a college savings plan account registry, a method for donating funds to a college savings plan account through the registry, and a method for managing contributions to a college saving plan account through the registry.

2. Background Art

The cost of a college education continues to rise at a pace that exceeds the overall rate of inflation. As a result, many people are finding that the task of funding a college education for their children, grandchildren, or other prospective students is becoming very difficult, and sometimes unrealistic, without advanced planning. These individuals are often in need of guidance and information regarding such advanced planning, and in particular for the many savings and investment programs that are available to help achieve the goal of funding a college education. Moreover, these individuals are often in need of additional sources of funds to invest in such programs. For the purpose of consistency and convenience, the savings and investment programs that are available to finance higher education shall be referred to herein as college saving plans.

Such college savings plans are known to those skilled in the art and include, by way of example: Section 529 plans, which are tuition savings programs established by individual states pursuant to 26 U.S.C. §529; Coverdell Education Savings Accounts; Uniform Gift to Minor's Act (UGMA) accounts; Uniform Transfer to Minors Act (UTMA) accounts; and other savings and/or investment plans that may be used to save or invest funds in order to pay for higher education.

Some institutions establish, or sponsor, one or more of these college savings plans and also act as the plan manager. The plan manager typically handles investment management, marketing and distribution, as well as some administration and record keeping for each plan. Other institutions that sponsor a college savings plan, such as a State that sponsors a Section 529 Plan, may engage the services of a private investment or brokerage firm to act as the plan manager. In any event, communication from the public to a plan sponsor typically is through the plan manager. Therefore, for the purpose of consistency and convenience, reference herein will be made to “sponsor” with the understanding that such reference includes college savings plan sponsors and their respective plan managers.

When an individual desires to establish a college savings plan to fund a college education for a prospective student, the plan sponsor typically allows an account to be opened directly with the sponsor. However, the plan sponsor also frequently works with financial advisors, who provide advice to those who are saving and investing for college, and may recommend one or more specific college savings plans. In these cases, the financial advisor often works with the prospective student and/or individual who desires to open the college savings plan account, and then works with the plan sponsor to open the desired account, and may provide some additional management of the account funds.

As known to those skilled in the art, such financial advisors usually have one or more licenses and/or designations, such as Registered Representative, Registered Investment Advisor, Investment Advisor Representative, Certified Financial Planner, Certified Public Accountant, Certified College Planning Specialist, Chartered Life Underwriter and Chartered Financial Consultant. Furthermore, these financial advisors may be employed by or affiliated with financial institutions such as broker-dealers, registered investment advisors, accounting firms, financial planning firms, banks, and savings and loan institutions.

When a particular college savings plan account is opened, the account typically at some point includes the name of the prospective student, who will receive the funds in the account for higher education, such as college tuition and expenses. However, since the prospective student typically is a minor when the account is opened, the account usually also includes the name of an adult. Depending on the type of college savings plan account that is opened, the adult may be dubbed the custodian of the account, the owner of the account, or given one of several other titles used in the art. For the purpose of consistency and convenience, reference herein shall be made to “custodian” as the adult whose name is included on the college savings plan account. Thus, when a parent opens a college savings plan account for a child who is the prospective student, the child's name is included on the account, and so is the parent's name. Of course a situation may arise in which the prospective student is old enough to be considered an adult, in which case a custodian may not be named on the college savings plan account, and the prospective student may direct certain activity in place of the custodian.

In most situations, the plan sponsor allows only the financial advisor, the custodian, and/or the prospective student to access the account to verify and/or manage the funds therein. In contrast, any individual may contribute funds to the college savings plan account, as long as that individual has certain detailed information regarding the account, such as the name and contact information of the plan sponsor, and the specific number of the savings plan account. However, it becomes extremely cumbersome for certain individuals, such as relatives and friends of the prospective student, to donate funds to the college savings plan account. More particularly, these donors typically do not have the contact information for the plan sponsor, and the account number, unless the prospective student or the custodian takes the time to personally communicate this information to them. Due to the time and effort involved in communicating such information, and the additional hesitance of many prospective students and custodians to communicate such information to others due to the personal nature of these accounts, it is infrequently done. Moreover, if a prospective student has multiple college savings plan accounts, or if one account is closed and another is opened, it becomes quite time consuming for the prospective student and/or custodian to relay such updated account information to others.

As a result, when relatives or friends desire to make a contribution to a college savings plan account, they typically give their contributions to the custodian and/or prospective student in the form of a check or cash. The custodian or prospective student must then in turn deposit the contribution into the account via the plan sponsor or financial advisor. This procedure is undesirable for many relatives and/or friends who wish to contribute to a college savings plan account, as their contributions may place a burden on the custodian and/or prospective student, who has to take the time to arrange for the deposit of their contributions. In addition, these relatives and/or friends may want to ensure that their contributions are promptly deposited in the desired college savings plan account, rather than giving a check or cash to the custodian or prospective student to deposit. Furthermore, in the event that a college savings plan has not yet been opened for a prospective student, but a potential donor would like to make a contribution toward the cost of the prospective student's future education, the lack of an existing account becomes a deterrent to such a contribution.

Such concerns of relatives and/or friends may become particularly pertinent at a birthday party or some other celebration for a prospective student of a college savings plan, since it may be desirable to make a contribution to the college savings plan account in place of giving a toy, clothing or other gift to the prospective student. Due to the aforementioned concerns associated with the prior art system of giving the contribution to the custodian and or prospective student of the account, these relatives and/or friends sometimes refrain from making a desired contribution to the account, or are at least hesitant to make such a contribution.

Thus, a need exists in the art for a college savings plan registry that overcomes the problems of the prior art by enabling easy and convenient contribution of funds to college savings plan accounts. A need also exists in the art for a method for donating funds to college savings plan accounts, and for managing the contributions to such accounts, in an easy and convenient manner. The present invention provides such a college savings plan registry, a method for donating funds to college savings plan accounts, and a method for managing the contributions to such accounts.

### BRIEF SUMMARY OF THE INVENTION

An objective of the present invention is to provide a college savings plan registry having the ability to easily and conveniently receive funds that are contributed to college savings plan accounts.

Another objective of the present invention is to provide a method for donating funds to college savings plan accounts in an easy and convenient manner.

Yet another objective of the present invention is to provide a method for managing contributions to college savings plan accounts in an easy and convenient manner.

These objectives and others are obtained by the college savings plan registry of the present invention, the general nature of which may be stated as including a central database. The database includes a plurality of registry accounts, and each of the registry accounts includes an account number of a college savings plan account and a name of a prospective student included in the college savings plan account.

These objectives and others are also obtained by the method for donating funds to a college savings plan account of the present invention, the general nature of which may be stated as including the steps of providing at least one college savings plan account that includes the name of a prospective student, and providing a registry for the at least one college savings plan account. Funds are contributed to the registry and are transferred from the registry to the at least one college savings plan account.

These objectives and others are also obtained by the method for managing contributions to a college savings plan account of the present invention, the general nature of which may be stated as including the steps of providing at least one college savings plan account that includes the name of a prospective student and providing a registry for the at least one college savings plan account. An account is opened in the registry for the at least one college savings plan account, and funds that are contributed to the at least one college savings plan account are received in the registry account. The registry account is accessed remotely and information regarding the contributed funds is received.

### BRIEF DESCRIPTION OF THE SEVERAL VIEWS OF THE DRAWINGS

The preferred embodiments of the invention, illustrative of the best mode in which applicant has contemplated applying the principles of the invention, are set forth in the following description and are shown in the drawings, and are particularly and distinctly pointed out and set forth in the appended claims.

FIG. 1 is a schematic block diagram showing a representation of the college savings plan account registry of the present invention, and a portion of the interaction between the registry and certain users of the registry;

FIG. 2 is a flowchart showing a first exemplary method for establishing registry account in the college savings plan account registry of the present invention;

FIG. 3 is a flowchart showing a second exemplary method for establishing registry account in the college savings plan account registry of the present invention;

FIG. 4 is a flowchart showing a first exemplary method for contributing to a college savings plan account using the college savings plan account registry of the present invention;

FIG. 5 is a flowchart showing a second exemplary method for contributing to a college savings plan account using the college savings plan account registry of the present invention; and

FIG. 6 is a flowchart showing a first exemplary method for accessing, managing contributions to a college savings plan account using the college savings plan account registry of the present invention.

Similar numerals refer to similar parts throughout the drawings.

### DETAILED DESCRIPTION OF THE INVENTION

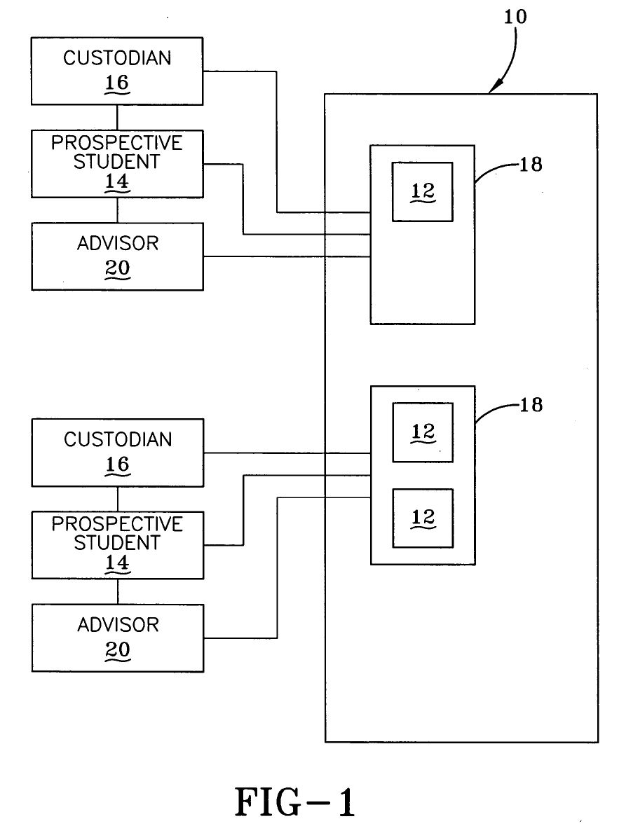

Turning now to the drawings, wherein the illustrations are provided to show preferred embodiments of the invention and not to limit the same, the college savings plan registry of the present invention is shown in FIG. 1 and is indicated generally at 10. Registry 10 facilitates access to and donation to one or more college savings plan accounts 12 and is embodied as a database on a computer or a computer system. Registry 10 includes information pertaining to individual college savings plan accounts 12, including information that identifies a specific prospective student 14 included in a college savings plan account, such as the name, address, date of birth and social security number of the prospective student, and preferably also includes similar identifying information associated with a custodian 16 who has established the account for the prospective student, or is otherwise named on the account. Registry 10 also stores data pertaining to each college savings plan account 12, which may include: the college savings plan account number; identification of the type of account, such as a Section 529 plan, a Coverdell Education Savings Account, etc.; the name of the plan sponsor; the name of a financial advisor used by the custodian and/or prospective student; the name of a broker-dealer or financial institution affiliated with the financial advisor; and/or any other identifying information known to one skilled in the art.

Registry 10 correlates the information that identifies a specific prospective student 14 and the information of the prospective student's college savings plan account 12 so that once the prospective student is identified, the information pertaining to the prospective student's college savings plan account is also identified. Furthermore, registry 10 correlates information pertaining to all college savings plan accounts 12 in which a specific prospective student 14 is included, so that when one prospective student is identified, all college savings plan accounts for that prospective student are identified. As will be described in greater detail below, a registry account 18, which has a first identification number or code, preferably is used to facilitate ready identification of prospective student 14 and all college savings plan accounts 12 for that prospective student.

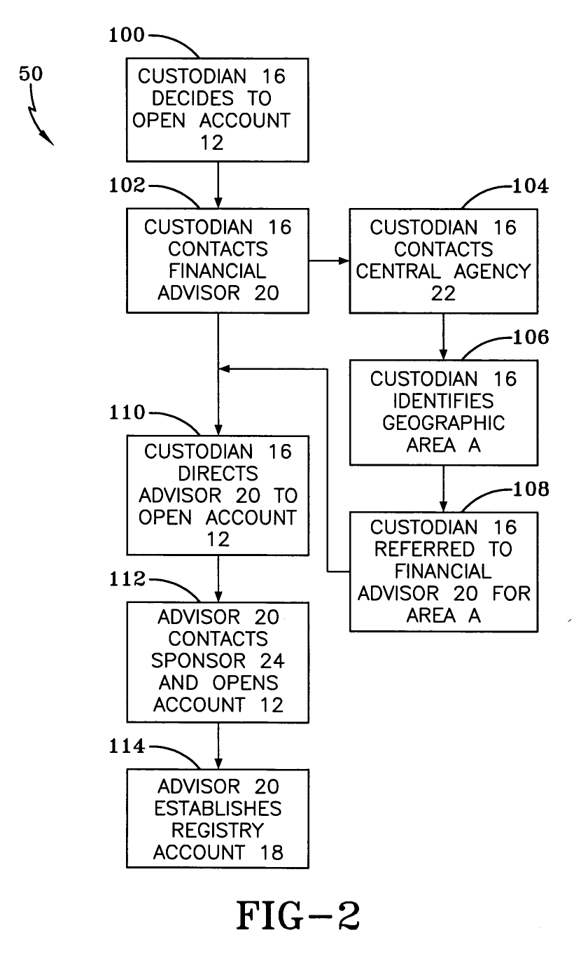

With additional reference now to FIG. 2, a first exemplary method for establishing registry account 18 is shown and is generally indicated at 50. Custodian 16 decides to create at least one college savings account 12 for prospective student 14, step 100. Custodian selects and contacts a financial advisor 20, step 102. Custodian 16 optionally selects financial advisor 20 from a central agency 22 based on geographic area. More particularly, if custodian 16 is in a geographic area represented by letter A, which may be a certain city and state, the custodian preferably selects and contacts financial advisor 20 who is located within or otherwise associated with geographic area A.

To facilitate the selection and contact of financial advisor 20 in geographic area A by custodian 16, central agency 22 assigns each financial advisor to a geographic territory, which preferably is the geographic area in which that financial advisor works. Therefore, one financial advisor 20, who works in geographic area A, would be assigned to receive contact from custodian 16 in geographic area A, while another financial advisor, who works in geographic area B, would be assigned to receive contact from an custodian in geographic area B. To provide the connection from custodian 16 in area A to financial advisor 20 in area A, the custodian contacts central agency 22, step 104, by known means of communication, such as: a telephone call to the central agency, which preferably is made to an easy-identifiable toll-free number such as 1-800-529-PLAN; an electronic mail message to the central agency; a visit to the Internet site of the central agency; or by letter or facsimile to the central agency. Upon such contact with central agency 22, custodian 16 identifies his or her geographic area, step 106, and the central agency refers the custodian to financial advisor 20, step 108, who is assigned to the territory that includes the geographic area of the custodian.

It should be noted that financial advisors 20 available through central agency 22 optionally are selected according to certain qualifications, such as registered representatives of a certain broker-dealer, or advisors who have earned the Certified College Planning Specialist designation, as known in the art, or combinations thereof.

Upon custodian 16 contacting financial advisor 20, the financial advisor and the custodian preferably review the goals of the custodian and at least some of the types of college savings plans 12 that are known to those in the art, as described above. If custodian 16 chooses to proceed with the establishment of one or more college savings plan accounts 12, the custodian directs financial advisor 20 to set up the desired college savings plan account or accounts for prospective student 14, step 110.

Preferably, financial advisor 20 then contacts an appropriate plan sponsor 24 for each college savings plan account 12 that is to be established by custodian 16 for prospective student 14, step 112. It is to be noted that custodian 16 may direct financial advisor 20 to contact a specific plan sponsor 24 of a certain type of college savings plan account 12, or the custodian may leave the selection of the specific plan sponsor and type of college saving plan account up to the financial advisor. If one or more of the particular college savings plan accounts 12 that are being established require an initial deposit of funds, financial advisor 20 preferably obtains the initial deposit from custodian 16 and forwards it to plan sponsor 24. Likewise, also in step 112, financial advisor 20 obtains all information necessary to establish each college savings plan account 12 from custodian 16 and forwards it to plan sponsor 24 to complete establishment of each respective college savings plan account.

Once each college savings plan account 12 is established, financial advisor 20 preferably accesses registry 10 to establish registry account 18 for prospective student 14, step 114. More particularly, financial advisor 20 accesses registry 10 preferably by visiting an Internet site of the registry and, using a selected access code for that financial advisor, opens registry account 18 for prospective student 14. Once financial advisor 20 accesses registry 10, the advisor enters the identifying information described above for prospective student 14, and optionally for custodian 16, and the identifying information described above for each college savings plan account 12 established by the financial advisor which names that specific prospective student. Alternatively, financial advisor 20 may have a direct computer link to registry 10, or may contact a central facilitator (not shown) of the registry 10 via a telephone call, an electronic mail message, a letter or a facsimile. The central facilitator of registry 10 then obtains from the financial advisor the previously-described information to establish registry account 18, and in turn establishes the registry account for prospective student 14.

It should be noted that, in first exemplary method 50 for establishing registry account 18, financial advisor 20 optionally performs step 114 before step 112. More particularly, financial advisor 20 may create registry account 18, and deposit any funds from custodian 16 and/or prospective student 14 into the registry account. Then, financial advisor 20 establishes one or more college savings plan accounts 12 with plan sponsor(s) 20, as described above in step 112. Once college savings plan account 12 is created, financial advisor 20 accesses registry 10 and enters the college savings plan account information into registry account 18, which enables the funds in the registry account to be transferred into the college savings plan account.

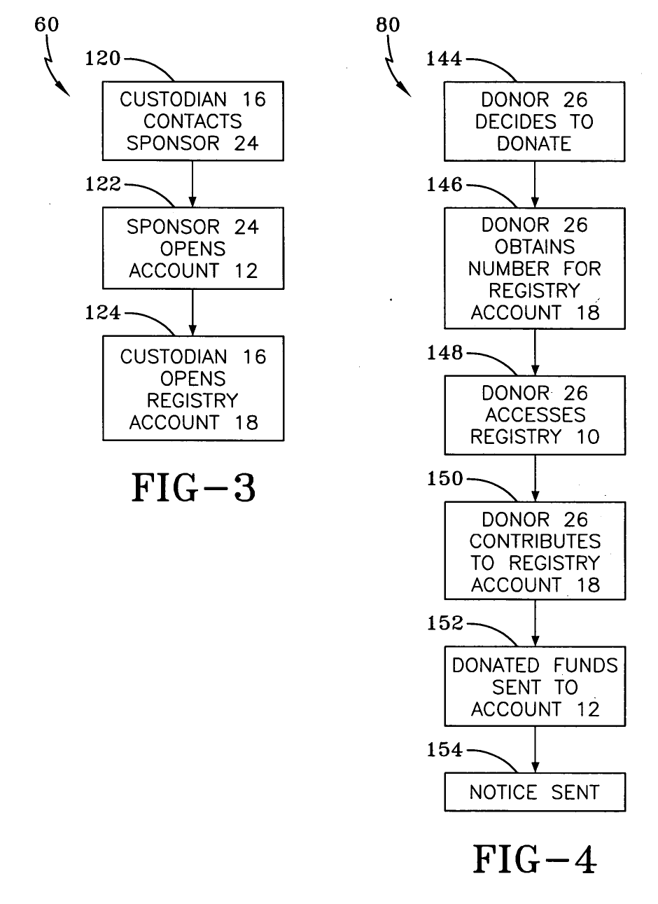

With reference now to FIGS. 1 and 3, a second exemplary method for establishing registry account 18 is shown and is indicated generally at 60. In second exemplary method 60, custodian 16 contacts college savings plan sponsor 24 directly, step 120. A representative of plan sponsor 24 optionally reviews the goals of custodian 16 and at least some of the types of college savings plans 12 that are known to those in the art, as described above. If custodian 16 chooses to proceed with the establishment of one or more college savings plan accounts 12, the custodian directs the representative of plan sponsor 24 to set up the desired college savings plan account or accounts for prospective student 14, step 122. If one or more of the particular college savings plan accounts 12 that are being established require an initial deposit of funds, plan sponsor obtains the initial deposit from custodian 16. Likewise, also in step 122, plan sponsor 24 obtains all information necessary to establish each college savings plan account 12 from custodian 16 to complete establishment of each respective college savings plan account.

Once each college savings plan account 12 is established, custodian 16 accesses registry 10 to establish registry account 18 for prospective student 14, step 124. More particularly, custodian 16 accesses registry 10 through the means described above, and enters the identifying information described above for prospective student 14, and optionally for custodian 16, and the identifying information described above for each college savings plan account 12 which names that specific prospective student. Alternatively, custodian 16 may contact a central facilitator (not shown) of registry 10 using the above-described means, and the facilitator obtains from the custodian the previously-described information to establish registry account 18, and in turn establishes the registry account for prospective student 14.

It should be noted that step 124 may be executed before steps 120 and 122. That is, custodian 16 may first access registry 10 to set up registry account 18 for prospective student 14, step 124, and may then contact sponsor 24, step 120, and direct the sponsor to open at least one college savings plan account 12, step 122. Once college savings plan account 12 is created, custodian 16 accesses registry 10 and enters the college savings plan account information into registry account 18, which enables any funds in the registry account to be transferred into the college savings plan account.

It is to be noted that when multiple college savings plan accounts 12 are present for a single prospective student 14, preferably all such college savings plan accounts are entered into one registry account 18 for that prospective student. Then custodian 16 and/or prospective student 14 preferably determine how any contributions to registry account 18 are to be divided among college savings plan accounts 12, as will be described below.

Once registry account 18 has been opened for a selected prospective student 14, the process of contributing or donating to college savings plan accounts 12 for the prospective student is simplified by registry 10. Turning now to FIG. 4, a first exemplary method for a donor 26 who desires to contribute to college savings plan accounts 12 for prospective student 14 using registry 10 is shown, and is indicated generally at 80. In first exemplary method of donating 80, donor 26 decides to contribute to college savings plan accounts 12 for prospective student 14, step 144. Donor 26 receives the number of registry account 18 for prospective student 14, preferably from the prospective student or custodian 16, as well as the uniform resource locator or domain name of an Internet web site at which registry 10 can be accessed, and/or a telephone number at which the facilitator of the registry can be accessed, step 146. Donor 26 then accesses registry 10 via the registry's Internet web site, or by calling the facilitator of the registry, step 148.

Using the number of the specific registry account 18 for prospective student 14, donor 26 uses payment means to donate a specific amount of money to the prospective student's registry account, step 150. Such payment means may include, by way of example, a credit card, an account that is established with registry 10 in which donor 26 is billed later, sending a check to the registry facilitator, or other modes of payment known in the art. The funds that are donated to registry account 18 preferably are then forwarded to college savings plan account 12 by registry 10, or to plan sponsor 24 for deposit into the plan account, step 152.

When prospective student 14 has multiple college savings plan accounts 12, the funds preferably are divided and sent to each respective college savings plan account according to a predetermined ratio that is set by the prospective student and/or custodian 16. For example, if two college savings plan accounts 12 are present in selected registry account 18, prospective student 14 and/or custodian 16 may specify that 50% of any donated funds go into the first college savings plan account and 50% go into the second college savings plan account, or that 70% go into the first account and 30% go into the second account. It is to be noted that when donor 26 contributes funds to registry account 18, a service fee for the use of registry 10 optionally may be added to the donated funds, or may be deducted from the donated funds before they are forwarded to college savings plan account 12.

Optionally, notice of the donation may be sent to prospective student 14 and/or custodian 16 by, or at the direction of, registry 10, step 154. The notice preferably identifies the name of donor 26, which was entered in registry 10 in step 150 while making a credit card or an account donation, the amount donated and the date of donation. The notification may be in the form of an electronic mail message sent to prospective student 14 and/or custodian 16, or an electronic or paper greeting card sent to the prospective student and/or the custodian. More particularly, once the donation has been made in step 150, registry 10 informs donor 26 that a confirmation will be sent to prospective student 14 and/or custodian 16, preferably via an electronic mail message, and asks the donor if he or she would like to customize the confirmation with a greeting, or change the confirmation from an electronic mail message to an electronic greeting card or a paper greeting card. In step 154, registry 10 accepts the instructions of donor 26 and generates the appropriate electronic mail message or electronic greeting card and sends it to selected prospective student 14 and/or custodian 16, or instructs the registry facilitator to send a pre-selected paper greeting card to the prospective student and/or custodian.

It is to be noted that donor 26 optionally accesses registry account 18 through financial advisor 20. That is, in step 148, donor 26 contacts financial advisor 20 directly or through central agency 22, which connects him to an appropriate financial advisor as described above, and the donor communicates his or her desire to contribute funds to college savings plan accounts 12 for prospective student 14. Financial advisor 20 then accesses registry account 18 for donor 26 in step 148 and assists the donor in contributing funds as described above in step 150, or contributes the funds for the donor and is reimbursed by the donor. When financial advisor 20 is involved in the donation of funds, the notice of donation in step 154 preferably also is sent to the financial advisor.

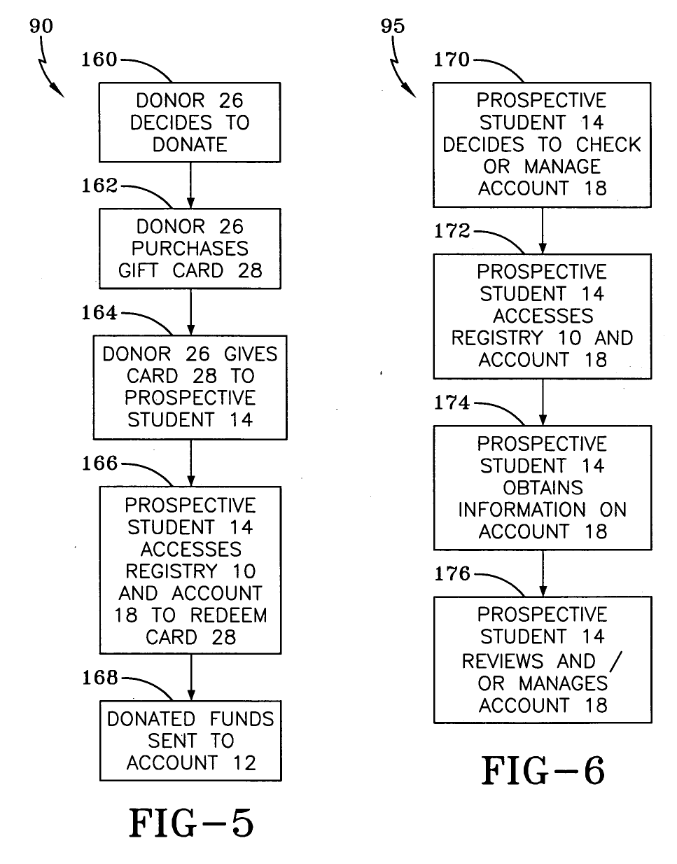

Turning now to FIG. 5, a second exemplary method for donor 26 desiring to contribute to college savings plan accounts 12 for prospective student 14 using registry 10 is shown, and is indicated generally at 90. Second exemplary donation method 90 involves using a gift card 28 to donate to college savings plan account(s) 12 for prospective student 14. Gift card 28 is sold to donor 26 through any one of a variety of channels, which will be described in greater detail below, thereby enabling the card to conveniently be given as a gift to prospective student 14.

In second exemplary method of donating 90, donor 26 decides to contribute to college savings plan accounts 12 for prospective student 14, step 160. Donor then purchases gift card 28, step 162. Gift card 162 is available for purchase in step 162 through a variety of retail shopping means. For example, gift card 28 may be purchased via computer through an Internet web site, or via telephone from the facilitator of registry 10 or from a mail-order service. Such a purchase over the Internet or the phone provides a convenient manner for donor 26 to obtain gift card having a dollar value that is decided upon by the donor and is paid for by using a credit card, debit card or payment account, as known to those in the art. Gift card 28 may be offered in a series of denominations, allowing donor 26 to choose from, for example, a gift card of $20, $25, $50, etc., or the gift card may be coded with a specific amount set forth by the donor. Gift card 28 then is delivered to donor 26 via mail, or directly to prospective student 14 at the donor's request.

Gift card 28 may also be sold at kiosks or vending machines located at malls, airports, and other public locations, as well as through retail stores. To enable convenient purchase of gift card 28, such sale locations may accept cash, debit card, credit card, or other means known in the art to purchase the gift card in step 162. In addition, gift card 28 may be distributed to potential donors without any stored value, through means such as mail, school programs, or other promotional distribution. A recipient of gift card 28, upon deciding to donate to college savings plan account 12 of prospective student 14 in step 160, becomes donor 26 and activates or add value to the gift card by accessing an Internet web site or by calling a specific telephone number, as described above for the purchase of the gift card through such means.

Once donor 26 has purchased gift card 28 or otherwise added stored value to the gift card as described above, the donor gives the gift card to prospective student 14 or custodian 16, step 164. In this manner, it is easy and convenient for a friend or relative of prospective student 14 to obtain gift card 28 and make a donation to the prospective student's college savings plan accounts 12 as a gift to be given at a special event such as a birthday or holiday, or at any other time. Of course, gift card 28 may be given directly to prospective student 14 or custodian 16 by donor 26, or it may be sent by another party on behalf of the donor, or given to a parent or other person responsible for the prospective student.

To facilitate easy and convenient addition of value, gift card 28 includes an identification number, which is either embedded in an electronically readable medium on the card, and/or printed on the card. In this manner, the specific gift card 28 purchased by donor 26, and the corresponding dollar amount on the card, is readily identifiable to facilitate correlation of the donation with registry account 18, as will be described below.

When prospective student 14 or custodian 16 receives gift card 28 from donor 26, the prospective student, custodian, or some other trusted agent thereof, such as a parent or guardian, accesses registry 10 to redeem the stored value on the gift card for distribution to college savings plan accounts 12, step 166. More particularly, prospective student 14, custodian 16 or other trusted agent preferably accesses registry 10 via a computer that is able to connect to the Internet site for the registry, or via a telephone call to the registry facilitator, and identifies the number of registry account 18, thereby obtaining access to the account. Prospective student 14, custodian 16 or other trusted agent enters the identification number of gift card 28, whereupon the stored value of the gift card is transferred into registry account 18. It should be noted that entry of the identification number of gift card 28 in registry 10 may optionally precede entry of the number for registry account 18, in which case the stored value on the gift card is transferred to the registry account once the account is accessed.

Alternative methods of redeeming gift card 28 in step 166 include prospective student 14, custodian 16 or other trusted agent visiting a retail location, kiosk or financial advisor 20 with access to registry 10, whereupon the prospective student, custodian or other trusted agent proceeds to redeem the stored value on the gift card as described above.

Once prospective student 14, custodian 16 or other trusted agent has transferred the stored value from gift card 28 into registry account 18, the donated funds are forwarded to college savings plan account 12 by registry 10, or to plan sponsor 24 for deposit into the plan account, step 168. When prospective student 14 has multiple college savings plan accounts 12, the donated funds preferably are divided and sent to each respective college savings plan account according to the above-described predetermined ratio that is set by the prospective student and/or custodian 16. Alternatively, when prospective student 14 has multiple college savings plan accounts 12, the prospective student, custodian 16 or trusted agent accessing registry account 18 is presented with a list of all of the college savings plan accounts for the prospective student upon accessing the registry account. Prospective student 14, custodian 16 or trusted agent may then choose a select account 12, or multiple accounts, into which he or she wishes the contributed funds to go, and then directs the desired portion of the donated funds to each account that has been selected.

It is to be noted that when gift card 28 is used, a service fee for the use of registry 10 optionally may be added to the donated funds at the time the card is purchased, or may be deducted from the donated funds before they are forwarded to college savings plan account 12. Optionally, confirmation of the redemption of gift card 28 may be sent to donor 26 in the manner described above for a donation of funds via the Internet or telephone.

It is to be noted that gift card 28 may optionally be designed with graphics or similar ornamentation to reflect a particular retail outlet or affiliation. Moreover, certain gift cards 28 may optionally be affiliated with a specific college savings plan sponsor 24, financial advisor 20, broker, and the like, which may receive credit for the use of the gift card, such as a percentage of the funds that are donated. Furthermore, certain gift cards 28 may optionally be affiliated with organizations or groups, such as charities or schools, which may receive credit for the use of the gift card, such as a percentage of the funds that are donated.

In order to encourage donations to college savings plan accounts 12, registry 10 optionally includes a matching program. More particularly, the registry facilitator or plan sponsor 24 may encourage contributions to college savings plan accounts 12 through registry 10 by matching certain contributions made through registry account 18. For example, the facilitator may agree to match 10% of the first $50,000 of funds contributed to college savings plan accounts 12 through registry 10.

When such matching is utilized, the registry facilitator may implement a vesting schedule, whereby the matching contributions become vested to prospective student 14 over a period of time. For example, the matching contribution could vest 20% per year so that if prospective student 14 canceled, closed or transferred registry account 18 from registry 10 after 2 years, but before 3 years, 40% of the matching contribution would be vested to registry account 18, and the remainder would be forfeited. In addition, investment gains and/or losses attributed to the matching contribution preferably would be vested and forfeited as well, on a pro-rata basis. Such a vesting schedule may encourage prospective student 14 and/or custodian 16 to maintain registry account 18 and continue to make or encourage contributions thereto.

Registry 10 may also optionally include incentives for prospective student 14 to encourage additional prospective students to enroll in the registry. For example, when registry account 18 is created for prospective student 14, registry 10 may optionally ask the prospective student for contact information for other potential higher education students, and may send a communication, such as an electronic mail invitation containing an electronic link to the registry, to those students. If any of those referred prospective students establish college savings plan accounts 12 and enroll in registry 10 by using the provided link, the registry facilitator makes a contribution or a series of contributions to registry account 18 of the referring prospective student 14, who provided the contact information. In addition, a contribution may be made to registry account 18 of the referring prospective student 14 by the registry facilitator whenever a contribution is made by donor 26 to the registry account of the referred prospective student.

With reference now to FIG. 6, a method of accessing registry 10 to manage contributions to college savings plan accounts 12 is shown and is indicated generally at 95. Using method 95, prospective student 14, custodian 16 and/or a trusted agent thereof is able to readily access registry 10 to manage contributions to college savings plan accounts 12. At least one of prospective student 14, custodian 16 and/or trusted agent decides to use registry account 18 to check or change the contribution allocation to one or more existing college savings plan accounts 12, step 170. When registry account 18 is initially created, prospective student 14 and/or custodian 16 is given a second registry account number, which is a number that allows access to the registry account for viewing and management of contributions to account funds, as opposed to the first registry account number, which allows access only for contribution to the registry account. Prospective student 14, custodian 16 and/or trusted agent accesses registry 10 via electronic communication with the Internet web site for the registry, or via a telephone call to the facilitator of the registry, and uses the second registry account number to open registry account 18, step 172.

Once registry account 18 is opened with the second account number, prospective student 14, custodian 16 and/or trusted agent is able to view the allocation of funds that are contributed to college savings plan accounts 12 in the registry account, step 174. For example, if prospective student 14 has three college savings plan accounts 12 registered in registry account 18, the of the prospective student is able to view the percentage of each contribution that goes into each respective first, second and third college savings plan accounts. Optionally, prospective student 14, custodian 16 and/or trusted agent is able to view a history of contributions to registry account 18, and is able to view any funds in the registry account that have not yet been transferred into college savings plan accounts 12, such as funds that are deposited in the registry account from a donor, as described above.

Upon receiving the allocation information in registry account 18, prospective student 14, custodian 16 and/or trusted agent may then use the registry account to adjust the allocation of funds into each college savings plan account 12, step 176. For example if the allocation had been set so that 35% of any contribution went into a first college savings plan account 12, and 65% went into a second account, prospective student 14, custodian 16 and/or trusted agent may change the allocation so that 50% of any future contributions will go into the first college savings plan account, and 50% will go into the second account. Moreover, an additional college savings plan account 12 can be added to registry account 18, and the allocation then adjusted accordingly in step 176. Optionally in step 176, if prospective student 14, custodian 16 and/or trusted agent receives information when accessing registry account 18 that indicates funds have been donated to the account, but have not been transferred to college savings plan accounts 12, the prospective student, custodian and/or trusted agent may then allocate the contributed funds to each college savings plan account as desired.

Registry 10 thus provides a convenient manner in which friends, relatives, and other donors 26 may make gifts to prospective students 14 that have or will have college savings plan accounts 12, and/or to custodians 16 who open such accounts for prospective students. As described above, such gifts are made in the form of deposits to college savings accounts 12 by accessing or contacting registry 10, identifying the appropriate registry account 18, and providing the funds to be contributed to the college savings plan accounts, or by purchasing gift card 28, which is redeemed by prospective student 14 or custodian 16.

Registry 10 preferably is a single, nation-wide registry. However, registry 10 may optionally be a regional registry, in which case multiple registries may co-exist and may optionally be coordinated to communicate with one another to allow contributions to move between them. For example, if a donation is made from one registry 10 in the northeast, the donation would be transferred to a desired registry account 18 of a prospective student 14 in a southwestern registry.

As mentioned above, registry 10 is computer-based. More particularly, registry 10 includes a database of registry accounts 18, each of which in turn includes information regarding each respective prospective student 14 and/or custodian 16, and information regarding each college savings plan account 12 in which the prospective student is included or named. Registry 10 may be stored on a single computer, multiple computers that communicate in a network, a computer network server, a mainframe computer, or any other known computer means. Registry 10 preferably is electronically connected to a computer system of the registry facilitator, and optionally to the respective computer systems of selected financial advisors 20, thereby enabling selective access to the registry by such sources. Registry 10 also preferably is electronically connected to the Internet and includes a corresponding Internet web site, thereby enabling access to the registry by custodians 16, prospective students 14, financial advisors 20, plan sponsors 24, donors 26 and others. As described above, registry 10 preferably includes the use of account numbers, as well as other means known to those skilled in the art, to provide selective and secure access to appropriate account information.

It should be noted that the transfer of funds from a specific registry account 18 to selected college savings plan accounts 12 includes means known to those in the art, such as a check or a wire transfer. Moreover, registry 10 may optionally include only certain types of college savings plan accounts 12, such as Section 529 Plan accounts, Coverdell Education Savings Accounts, and custodial (UGMA/UTMA) accounts sold by registered representatives of a particular broker-dealer.

It is to be noted that the arrangement of steps described above may be modified without affecting the overall concept or operation of the invention. For example, to encourage saving for higher education, gift card 28 may optionally be purchased before registry account 18 and/or college savings plan account 12 are opened, any may then be redeemed once the registry account and college savings plan account are opened. In addition, funds that are contributed by donor 26 may pass directly into college savings plan account 12 upon accessing registry 10, which may be facilitated by a direct link to sponsor 24 within the registry.

Accordingly, the college savings plan account registry, method for donating funds to a college savings plan account through the registry, and method for managing contributions to such accounts through the registry of the present invention is simplified, provides an effective, safe, inexpensive, and efficient structure and method which achieves all the enumerated objectives, provides for eliminating difficulties encountered with prior-art methods of donating to and managing college savings plan accounts, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the college savings plan account registry, method for donating funds to a college savings plan account through the registry, and method for managing contributions to such accounts through the registry is constructed, arranged and used, the characteristics of the construction and arrangement, and the advantageous, new and useful results obtained; the new and useful steps, structures, devices, elements, arrangements, parts and combinations, are set forth in the appended claims.

What is claimed is:

1. A registry of college savings plan accounts, comprising:
a central database, wherein said database includes a plurality of registry accounts, and wherein each of said registry accounts includes:
an account number of a college savings plan account; and
a name of a prospective student included in said college savings plan account.

2. The registry of college savings plan accounts of claim 1, wherein said registry account is accessible by at least one of said prospective student and a custodian.

3. The registry of college savings plan accounts of claim 1, wherein at least one of said registry accounts is created before opening said college savings plan account.

4. The registry of college savings plan accounts of claim 3, wherein a custodian directs a financial advisor to open said registry account.

5. The registry of college savings plan accounts of claim 3, wherein a custodian opens said registry account.

6. The registry of college savings plan accounts of claim 1, wherein at least one of said registry accounts is created after opening said college savings plan account.

7. The registry of college savings plan accounts of claim 6, wherein a custodian directs a financial advisor to open said registry account.

8. The registry of college savings plan accounts of claim 6, wherein a custodian opens said registry account.

9. The registry of college savings plan accounts of claim 1, wherein funds are added to said college savings plan account by a donor accessing said registry account.

10. The registry of college savings plan accounts of claim 1, wherein funds are added to said college savings plan account by a donor purchasing a gift card including stored value, and wherein said gift card is capable of being redeemed so that the value stored on said card is deposited through said registry account into said college savings plan account.

11. A method for donating funds to a college savings plan account, comprising the steps of:
providing at least one college savings plan account that includes a name of a prospective student;
providing a registry for said at least one college savings plan account;
contributing funds to said registry; and
transferring said funds from said registry to said at least one college savings plan account.

12. The method for donating funds to a college savings plan account of claim 11, further comprising the step of opening an account in said registry for said at least one college savings plan account, and said step of contributing funds to said registry includes contributing funds to said registry account, and said step of transferring said funds from said registry includes transferring said funds from said registry account to said at least one college savings plan account.

13. The method for donating finds to a college savings plan account of claim 12, wherein said prospective student is a first prospective student; and further comprising the step of contributing funds to said registry account for said at least one college savings plan of said first prospective student, when a second registry account is opened, upon referral from said first prospective student, for a second college savings plan account that includes the name of a second prospective student.

14. The method for donating funds to a college savings plan account of claim 13, further comprising the step of contributing funds to said registry account for said at least one college savings plan of said first prospective student, when a donation is made to said second registry account.

15. The method for donating funds to a college savings plan account of claim 12, wherein the step of providing at least one college savings plan account includes providing multiple college savings plan accounts for a single prospective student, and wherein the step of opening an account in said registry includes opening a single account in said registry for all of said multiple college savings plan accounts, and wherein the step of transferring said funds from said registry account includes transferring said funds from said registry account to selected ones of said multiple college savings plan accounts.

16. The method for donating funds to a college savings plan account of claim 15, wherein said selection is made by at least one of said prospective student and a custodian.

17. The method for donating funds to a college savings plan account of claim 11, wherein the step of contributing funds to said registry is performed by a donor accessing said registry.

18. The method for donating funds to a college savings plan account of claim 11, wherein the step of contributing funds to said registry is performed by a donor purchasing a gift card that is capable of being redeemed for value in said registry.

19. A method for managing contributions to a college savings plan account, comprising the steps of:
providing at least one college savings plan account that includes a name of a prospective student;
providing a registry for said at least one college savings plan account;
opening an account in said registry for said at least one college savings plan account;
receiving contributed funds for said at least one college savings plan account in said registry account;
accessing said registry account remotely; and
receiving information regarding said contributed funds.

20. The method for managing contributions to a college savings plan account of claim 19, wherein the step of providing at least one college savings plan account includes providing multiple college savings plan accounts for a single prospective student; and wherein the step of opening an account in said registry includes opening a single account in said registry for all of said multiple college savings plan accounts; and further comprising the step of managing an allocation of said contributed funds between said multiple college savings plan accounts.
